(19) United States
(12) Patent Application Publication
(10) Pub. No.: US 2013/0278494 A1
(43) Pub. Date: Oct. 24, 2013

(54) THREE-DIMENSIONAL INTERACTIVE SYSTEM

(71) Applicants: Shih-I Huang, Hsin-Chu (TW); Jui-Tzu Hua, Hsin-Chu (TW)

(72) Inventors: Shih-I Huang, Hsin-Chu (TW); Jui-Tzu Hua, Hsin-Chu (TW)

(73) Assignee: AU OPTRONICS CORP., Hsin-Chu (TW)

(21) Appl. No.: 13/610,881

(22) Filed: Sep. 12, 2012

(30) Foreign Application Priority Data
Apr. 18, 2012 (TW) 101113732

(51) Int. Cl. G06F 3/01

(52) U.S. Cl. 345/156

(57) ABSTRACT

A three-dimensional interactive system includes at least one image capturing device, a processor and a display. The at least one image capturing device is used for sensing positional changes of an object with time along three axes in three-dimensions. The processor is used for generating image data according to the positional changes of the object with time along the three axes. The display is used for displaying the image data.

### BACKGROUND OF THE INVENTION

1. Field of the Invention

The present invention relates to a three-dimensional interactive system, and more particularly to a three-dimensional interactive system capable of generating image data according to positional changes of an object with time along the three axes.

2. Description of the Prior Art

Liquid crystal displays (LCDs) are widely used nowadays. Due to their slim shapes, low power dissipation and low radiation, liquid crystal displays are widely applied on mobile electronic devices such as notebooks, monitors, and PDAs (personal digital assistants). Liquid crystal displays having touch input functions are also widely applied on more and more electronic devices as input interfaces.

Touch displays are widely applied on electronic products because touch displays are easy to operate and convenient. Further, using touch panels as interfaces for users to operate electronic products, users can directly control electronic products through touching touch displays without using a keyboard or a computer mouse, thus saving the space required for using a keyboard or a computer mouse.

However, when users cannot approach a touch display, or when the size of a touch panel is too large, e.g. larger than a 42-inch panel, the aforementioned method of directly controlling electronic products through touching touch displays may be undesirable, making the operating range and application scope limited. With increasing popularity of three-dimensional (3D) images, the aforementioned method cannot meet requirements of operating 3D images.

### SUMMARY OF THE INVENTION

An embodiment of the present invention provides a three-dimensional interactive system. The three-dimensional interactive system includes at least one image capturing device, a processor and a display. The at least one image capturing device is used for sensing positional changes of an object with time along three axes in three-dimensions. The processor is used for generating image data according to the positional changes of the object with time along the three axes. The display is used for displaying the image data.

Another embodiment of the present invention provides a three-dimensional interactive system. The three-dimensional interactive system includes at least one image capturing device, at least one depth sensor, a processor and a display. The at least one image capturing device and the at least one depth sensor are used for sensing positional changes of an object with time along three axes in three-dimensions. The processor is used for generating image data according to the positional changes of the object with time along the three axes. The display is used for displaying the image data.

Another embodiment of the present invention provides a three-dimensional interactive system. The three-dimensional interactive system includes at least one image capturing device, a depth sensor, a processor and a display. The at least one image capturing device and the depth sensor are used for sensing positional changes of an object with time along three axes in three-dimensions. The processor is used for generating image data according to the positional changes of the object with time along the three axes. The display is used for displaying the image data.

Another embodiment of the present invention provides a three-dimensional interacting method. The three-dimensional interacting method includes sensing positional changes of an object with time along three axes in three-dimensions, generating at least one image data according to the positional changes of the object with time along the three axes, and displaying the at least one image data.

Through utilizing the devices and methods provided by the embodiments of the present invention, the 3D interactive systems can generate corresponding image data according to the positional changes of the object with time along three axes in three-dimensions without using any keyboard or mouse. Besides, the 3D interactive systems can perform 3D operations to the image data according to the 3D positional changes of the object, and is not limited to merely 2D operation. Further, the 3D interactive systems can also provide pressure corresponding to the image data to the object through a force feedback kit to improve the interactive effect.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows a 3D interactive system according to a first embodiment of the present invention.

FIG. 2 shows a user using the 3D interactive system of FIG. 1 to generate image data.

FIG. 3 shows a 3D interactive system according to a second embodiment of the present invention.

FIG. 4 shows a 3D interactive system according to a third embodiment of the present invention.

FIG. 5 shows a 3D interactive system according to a fourth embodiment of the present invention.

### DETAILED DESCRIPTION

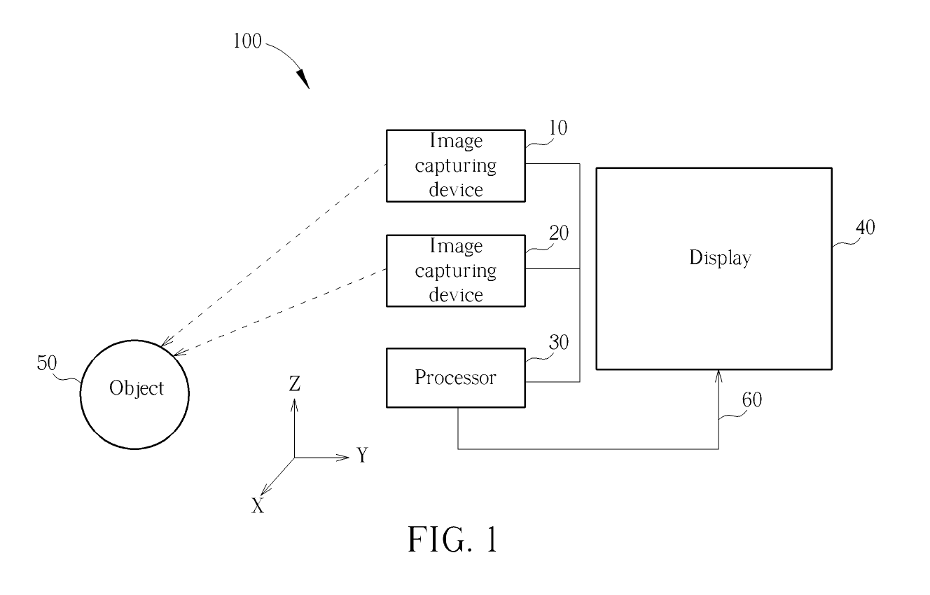

Please refer to FIG. 1, which shows a 3D interactive system 100 according to the first embodiment of the present invention. As shown in FIG. 1, the 3D interactive system 100 includes two image capturing devices 10 and 20, a processor 30 and a display 40. The image capturing devices 10 and 20 are used for sensing positional changes of an object 50 with time along the X, Y and Z axes in three-dimensions. The processor 30 is used for generating image data 60 according to the positional changes of the object 50 with time along the three axes. The display 40 is used for displaying the image data 60.

The object 50 can be referred to various types of objects, e.g. the hands, feet and head of a user are usually used as inputs. The image capturing devices 10 and 20 can be any devices having functions of capturing images, e.g. a camera lens. Through the configuration of two image capturing devices 10 and 20, the 3D location of the object 50 can be detected. The processor 30 can be personal computers, notebooks, TV gaming machines or smart mobile phones.

For example, when a user is using the 3D interactive system 100 to play games having 3d interactive effect, once the user enters a detectable area of the image capturing devices 10 and 20, image capturing devices 10 and 20 will generate 3D signals according to the motions of the hands (can also be the feet or head) of the user, and then the processor 30 generates image data 60 having 2D (two-dimensional) contents or 3D contents according to the generated 3D signals. After that, the processor 30 transmits the image data 60 to the display 40. The display 40 can display images having 2D or 3D effects according to the contents of the image data 60. Besides, the image data 60 can further include information of locations of the user's hands (can also be the feet or head) so that the 3D interactive system 100 can display virtual images of hands corresponding to the positional changes of user's hands with time along three axes in three-dimensions. Therefore, the user can know the moving direction of his/her hands and where to move his/her hands from the images displayed by the display 40.

Although in the example of the first embodiment, the 3D interactive device 100 only includes two image capturing devices 10 and 20, the present invention does not limit the number of image capturing devices of the 3D interactive device 100 to two. The 3D interactive device 100 can be configured as including a single image capturing device or more image capturing devices.

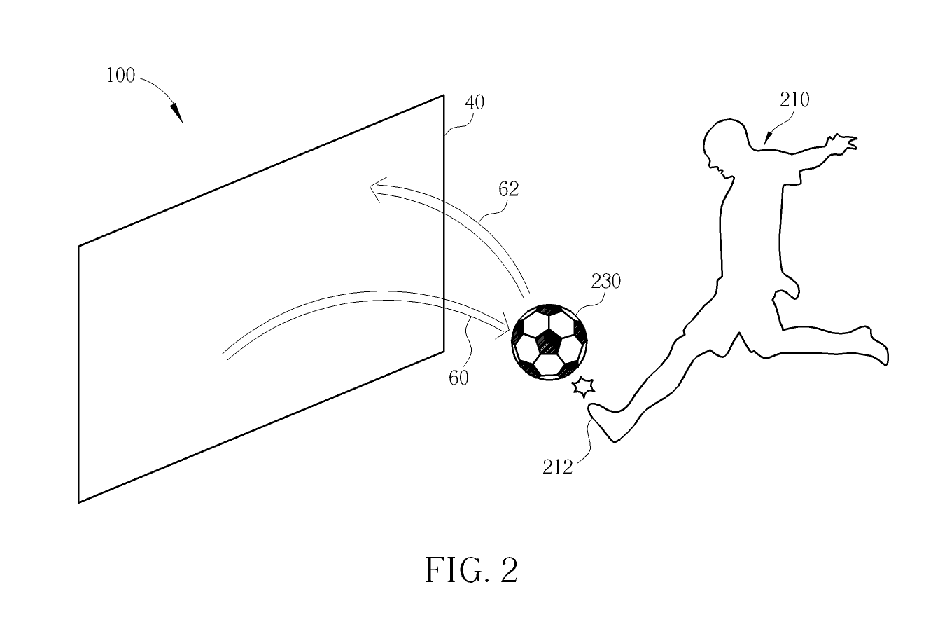

Please refer to FIG. 2, which shows a user using the 3D interactive system 100 of FIG. 1 to generate image data 60 and 62. As shown in FIG. 2, when a user 210 plays a video soccer game with the 3D interactive device 100, positional changes of the user 210 with time along three axes in three-dimensions will be sensed by the image capturing devices 10 and 20, thus the processor 30 can sequentially generate image data 60 and 62 corresponding to the image capturing devices 10 and 20, respectively, and then the display 40 displays the image data 60 and 62. The image data 60 is generated before the image data 62 is generated. The image data 60 shows a scenario that the image of a virtual soccer ball 230 is formed inside the display 40 and the image of the virtual soccer ball 230 is gradually approaching the user 210, and then the image of virtual soccer ball 230 is finally formed to appear as if outside the display 40.

When the image of the virtual soccer ball 230 is formed to appear as if outside the display 40 and near the user 210, if the user 210 kicks the virtual soccer ball 230 with his/her foot 212, the image capturing devices 10 and 20 will sense the positional changes of the foot 212 with time along X, Y and Z axes in three-dimensions, so that the processor 30 can judge the virtual soccer ball 230 is being kicked, and generate the image 62 according to how the virtual soccer ball 230 is being kicked. The image data 62 shows a scenario that the image of a virtual soccer ball 230 is formed to appear as if outside the display 40 and the image of the virtual soccer ball 230 is gradually departing away from the user 210, and then the image of virtual soccer ball 230 is finally formed to appear as if back inside the display 40. The moving speed of the virtual soccer ball 230 moving toward the user 210 from inside to outside the display 40 or from outside to inside the display 40 is based on the strength and velocity of the user 210 kicking the virtual soccer ball 230 and may vary. Besides, the image data 60 and 62 can further include the information of the position of the foot 212 to make the 3D interactive device 100 display a virtual foot corresponding to the foot 212, and the image of the displayed virtual foot changes with the positional changes of the foot 212 with time along three axes in three-dimensions. Therefore, the user 210 can know the exact moving direction of his/her foot 212 and whether the virtual soccer ball 230 is being kicked or not.

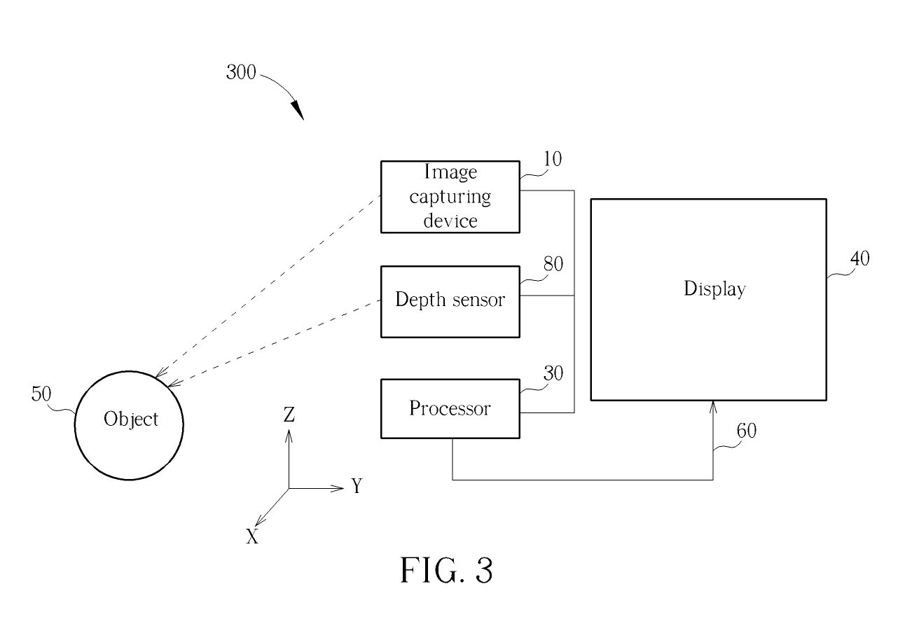

Please refer to FIG. 3 that shows a 3D interactive system 300 according to the second embodiment of the present invention. As shown in FIG. 3, the 3D interactive system includes an image capturing device 10, a depth sensor 80, a processor 30 and a display 40. The image capturing device 10 and the depth sensor 80 are used for sensing positional changes of an object with time along three axes in three-dimensions. The processor 30 is used for generating image data 60 according to the positional changes of the object 50 with time along the three axes. The display is used for displaying the image data. The difference between the 3D interactive system 300 and the 3D interactive system 100 is that the 3D interactive system 300 senses positional changes of the object 50 with time along three axes in three-dimensions with one image capturing device 10 and the depth sensor 80 rather than using two image capturing devices 10 and 20. The depth sensor 80 is utilized to sense the distance between the object 50 and the 3D interactive system 300 through calculating the time difference between the time of transmitting a signal to the object 50 and the time of receiving a reflected signal from the object 50, e.g. an infrared ray device. Similarly, through utilizing the image capturing device 10 and the depth sensor 80, the positional changes of the object 50 relative to the 3D interactive system 300 with time along the three axes can be sensed.

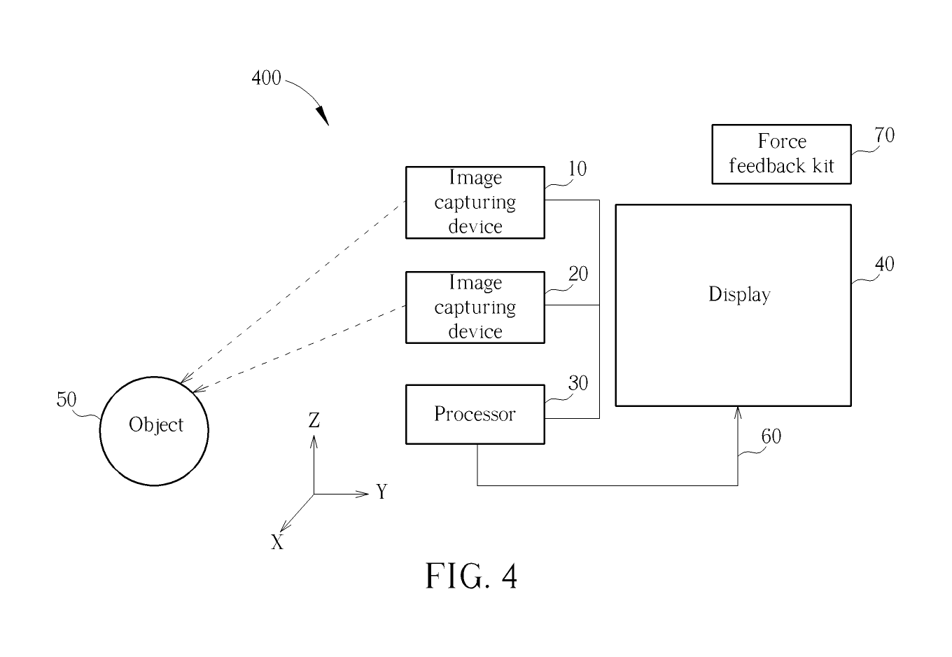

Please refer to FIG. 4, which shows a 3D interactive system 400 according to third embodiment of the present invention. The difference between the 3D interactive system 400 and the 3D interactive system 100 is that the 3D interactive system 400 further includes a force feedback kit 70 used for providing pressure to the object 50. The force feedback kit 70 can be sensing devices such as gloves, helmets or footwear. The force feedback kit 70 can put pressure on users to make them feel various levels of strength through vibrating or shaking, etc. For example, when the user 210 is using the 3D interactive system 400 to play the video soccer game illustrated in FIG. 2, if the user 210 wears a foot sleeve with a force feedback function on the foot 212, the foot sleeve will provide pressure to the foot 212 of the user 210 when the virtual soccer ball 230 is kicked by the foot 212. Besides, the foot sleeve can generate various corresponding vibration levels and pressure levels according to the positional changes of the foot 212 with time along x, y and z axes in three-dimensions.

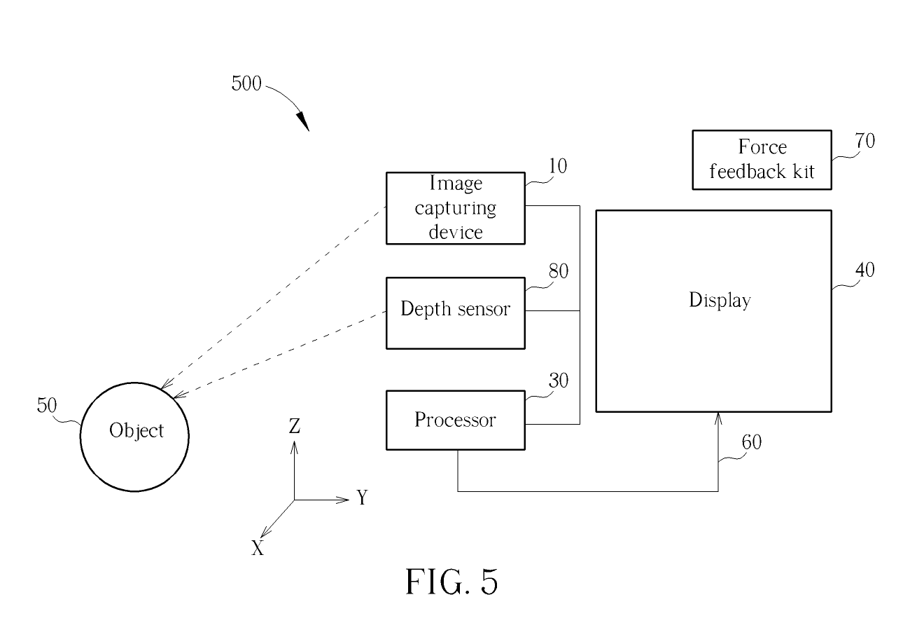

Please refer to FIG. 5 that shows a 3D interactive system 500 according to the fourth embodiment of the present invention. The difference between the 3D interactive system 500 and the 3D interactive system 300 is that the 3D interactive system 500 further includes a force feedback kit 70 used for providing pressure to the object 50. Similarly, when the user 210 is using the 3D interactive system 400 to play the video soccer game illustrated in FIG. 2, if the user 210 wears a foot sleeve with a force feedback function on the foot 212, the foot sleeve will provide pressure to the foot 212 of the user 210 when the virtual soccer ball 230 is kicked by the foot 212. Besides, the foot sleeve can generate various corresponding vibration levels and pressure levels according to the positional changes of the foot 212 with time along X, Y and Z axes in three-dimensions.

Through utilizing the devices and methods provided by the embodiments of the present invention, the 3D interactive systems 100, 300, 400 and 500 can generate corresponding image data 60 according to the positional changes of the object 50 with time along three axes in three-dimensions without using any keyboard or mouse. Besides, the 3D interactive systems 100, 300, 400 and 500 can perform 3D operations on the image data 60 according to the 3D positional changes of the object 50, and is not limited to merely 2D operation. Further, the 3D interactive systems 400 and 500 can further provide pressure corresponding to the image data 60 to the object 50 through a force feedback kit 70 to improve the interactive effect.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A three-dimensional interactive system, comprising:
at least one image capturing device for sensing positional changes of an object with time along three axes in three-dimensions;
a processor for generating image data according to the positional changes of the object with time along the three axes; and
a display for displaying the image data.

2. The three-dimensional interactive system of claim 1, further comprising at least one force feedback member for applying pressure to the object.

3. The three-dimensional interactive system of claim 2, wherein the at least one force feedback member is further configured to apply pressure to the object when a displayed position of image data of the object intersects a displayed position of image data a predetermined virtual object.

4. The three-dimensional interactive system of claim 1, wherein the three axes are perpendicular to one another.

5. The three-dimensional interactive system of claim 1, wherein the at least one image capturing device comprises a depth sensor.

6. A three-dimensional interactive system, comprising:
at least one image capturing device and a depth sensor, for sensing positional changes of an object with time along three axes in three-dimensions;
a processor for generating image data according to the positional changes of the object with time along the three axes; and
a display for displaying the image data.

7. The three-dimensional interactive system of claim 6, further comprising at least one force feedback member for applying pressure to the object.

8. The three-dimensional interactive system of claim 7, wherein the at least one force feedback member is further configured to apply pressure to the object when a displayed position of image data of the object intersects a displayed position of image data a predetermined virtual object.

9. The three-dimensional interactive system of claim 6, wherein the three axes are perpendicular to one another.

10. A three-dimensional interacting method, comprising:
sensing positional changes of an object with time along three axes in three-dimensions;
generating at least one image data according to the positional changes of the object with time along the three axes; and
displaying the at least one image data.

11. The method of claim 10, wherein the three axes are perpendicular to one another.

12. The method of claim 10, wherein sensing the positional changes of the object with time along the three axes in three-dimensions is using at least one image capturing device to sense the positional changes of the object with time along the three axes in three-dimensions.

13. The method of claim 10, wherein sensing the positional changes of the object with time along the three axes in three-dimensions is using at least one image capturing device and at least one depth sensor to sense the positional changes of the object with time along the three axes in three-dimensions.

14. The method of claim 10, wherein generating the at least one image data according to the positional changes of the object with time along the three axes is generating at least one two-dimensional image data according to the positional changes of the object with time along the three axes, and displaying the at least one image data is displaying the at least one two-dimensional image data.

15. The method of claim 10, wherein generating the at least one image data according to the positional changes of the object with time along the three axes is generating at least one three-dimensional image data according to the positional changes of the object with time along the three axes, and displaying the at least one image data is displaying the at least one three-dimensional image data.

16. The method of claim 10, further comprising applying force to the object.

17. The method of claim 10, further comprising applying pressure to the object when a displayed position of image data of the object intersects a displayed position of image data a predetermined virtual object.
